(19) United States
(12) Patent Application Publication
(10) Pub. No.: US 2020/0153935 A1
(43) Pub. Date: May 14, 2020

(54) SYSTEM AND METHOD FOR ENRICHING CONSUMER MANAGEMENT RECORDS USING HASHED MOBILE SIGNALING DATA

(71) Applicant: GOLDENSPEAR LLC, San Francisco, CA (US)

(72) Inventors: Santos Moises Soto, San Francisco, CA (US); Anuradha Sridhar, Plano, TX (US); Mike Logan, Overland Park, KS (US); Chris Yenney, Frisco, TX (US); Javier Castan, Barcelona (ES)

(73) Assignee: GOLDENSPEAR LLC, San Francisco, CA (US)

(21) Appl. No.: 16/677,244

(22) Filed: Nov. 7, 2019

Related U.S. Application Data
(60) Provisional application No. 62/758,330, filed on Nov. 9, 2018.

(51) Int. Cl. H04L 29/08; G06F 21/62; G06N 20/00

(52) U.S. Cl. CPC H04L 67/306; G06N 20/00; H04L 67/22; G06F 21/6245

(57) ABSTRACT

A system is disclosed for sharing of encrypted personal identification information in such a way so as to maintain user privacy. In examples, the present system includes an onsite wireless device, an onsite wireless sensor, a remote event detection server, and a remote content database. The remote event detection server has an event detection engine based on certain signaling (or triggering) events within the wireless data network. The remote event detection server is connected to the remote content database that contains other ephemeral information related to a customer or subscriber (characteristics of browsers used, browsing history, login IDs, etc.). When a customer bearing a wireless device nears the wireless sensor, their presence triggers an event that is registered by the mobile network and detected by the event detection server. The event detection server registers this event and customer information in the remote content database using methods disclosed herein to maintain anonymity and privacy.

### PRIORITY CLAIM

The present application claims priority to U.S. Provisional Patent Application No. 62/758,330, entitled “SYSTEM AND METHOD FOR ENRICHING CONSUMER MANAGEMENT RECORDS USING HASHED MOBILE SIGNALING DATA”, filed on Nov. 9, 2018, which application is incorporated herein by reference in its entirety.

### BACKGROUND

The use of linguist or symbolic identifiers for segmentation is a fundamental element of human communications—essential to understanding if a given message is intended for a specific person, a group, or a whole society. Examples could include the ancient, such as surnames identifying familial relationships, or the modern such as street addresses for managing mail delivery to families living in close proximity or US Social Security Numbers for managing the fiscal obligations of individual taxpayers. The advent of the modern Internet has led to a proliferation of “ephemeral” identifiers such as email addresses, IP addresses, and login IDs that may be associated with an individual for a limited time. A significant challenge of this era, then, is how these identifiers may be appropriately used to deliver the benefits of more focused communication without violating the privacy concerns of individuals.

In the era of telephone communications, the specific discussions between individual users—as well and metadata related to those communications—was considered privileged information that could not be disclosed without legal authorization. Identifying information such as phone numbers could only be shared based on the user's consent and the use of metadata such as the pattern of all numbers called by a given customer was legally controlled. The regime of “Title 2” regulation has largely continued into the era of cellular communications.

Internet-based communications, by contrast, have been much less regulated, leading to tremendous financial opportunities and a dramatic loss of individual privacy. A typical on-line marketing campaign might include activities such as soliciting customers at point-of-sale for their email addresses or creating on-line accounts for storage of personal purchasing history.

But many companies, exploiting the regulatory void, have gone to much greater extremes to integrate the threads of information afforded by Internet technology to symbolically track individuals online, such as creating consortiums for the sharing of “cookies” meant originally only to provide stateful context for HTML, creating engaging entertainment applications with the ulterior motive of ensuring the user is frequently logged in on multiple devices, or even funding a “freeware” cell phone operating system to assert privileged access to metadata with minimal consent. At the extreme, companies may simply analyze the intimate content of privileged communications—voice or text—for commercial gain.

One way in which companies obtain personal identification information is through identifying that a person is at a particular location at a particular time. Information relating to visits to a particular location such as a retail store or entertainment venue have historically been ascertained in several ways:
Elective self-reporting (such as setting up a booth at an event to solicit customers)
Secondary reporting via social media
“Ad Geofencing” based on IP address, proprietary IP segmentation, purchased information, or similar means
GPS reporting, based on implied or real-time requested permissions from underlying infrastructure owners.

Of these methods, certainly human contact is the most expected and common practice. Indeed, humans universally visit specific venues or attend events specifically to participate in commerce for various goods and services (say an art fair or a tire store).

Methods such as social media or ad geofencing represent an advancement of this concept. On-line reporting or geofencing based on related metadata can be used in lieu of a physical presence to understand customer behaviors and to present ads to those customers (i.e. “retargeting”) based on information that the customer was likely exposed to at the event.

Real-time tracking of customer position via the GPS capabilities of a phone or similar device provides accurate and generalized information. However, such metadata may lack critical commercial context, such as determining whether a customer was truly inside a store or simply passing by, especially in cities with dense urban canyons. Additionally, the unfiltered use of such user information also raises privacy, personal security, and ownership-of-information concerns. Responsive to the use and exploitation of personal identification information, more so than ever, users are now sensitive to the privacy of their personal identification information.

### DESCRIPTION OF THE DRAWINGS

FIG. 1 is a block diagram of a system for implementing embodiments of the present technology.

FIG. 2 is a flowchart for the operation of embodiments of the present technology.

FIG. 3 is a block diagram of a system for implementing alternative embodiments of the present technology.

FIG. 4 is a block diagram of a system for implementing alternative embodiments of the present technology.

FIG. 5 is a block diagram of a mobile device such as a cellular telephone according to embodiments of the present technology.

FIG. 6 is a block diagram of a computing device according to embodiments of the present technology.

### DETAILED DESCRIPTION

The present technology will now be described with reference to the figures, which in embodiments, relate to a system for sharing of encrypted personal identification information in such a way so as to maintain user privacy. In embodiments, the present system includes an onsite wireless device, an onsite wireless sensor, a remote event detection server, and a remote content database. The remote event detection server has an event detection engine based on certain signaling (or triggering) events within the wireless data network. The remote event detection server is connected to the remote content database that contains other ephemeral information related to a customer or subscriber (characteristics of browsers used, browsing history, login IDs, etc.). When a customer bearing a wireless device nears the wireless sensor, their presence triggers an event that is registered by the mobile network and detected by the event detection server. The event detection server registers this event and customer information in the remote content database using methods disclosed herein to maintain anonymity and privacy. Source network events leading to the reported detection are subsequently discarded or archived per conventional wireless operational procedures.

It is understood that the present technology may be embodied in many different forms and should not be construed as being limited to the embodiments set forth herein. Rather, these embodiments are provided so that this disclosure will be thorough and complete and will fully convey the technology to those skilled in the art. Indeed, the technology is intended to cover alternatives, modifications and equivalents of these embodiments, which are included within the scope and spirit of the technology as defined by the appended claims. Furthermore, in the following detailed description of the present technology, numerous specific details are set forth in order to provide a thorough understanding of the present technology. However, it will be clear to those of ordinary skill in the art that the present technology may be practiced without such specific details.

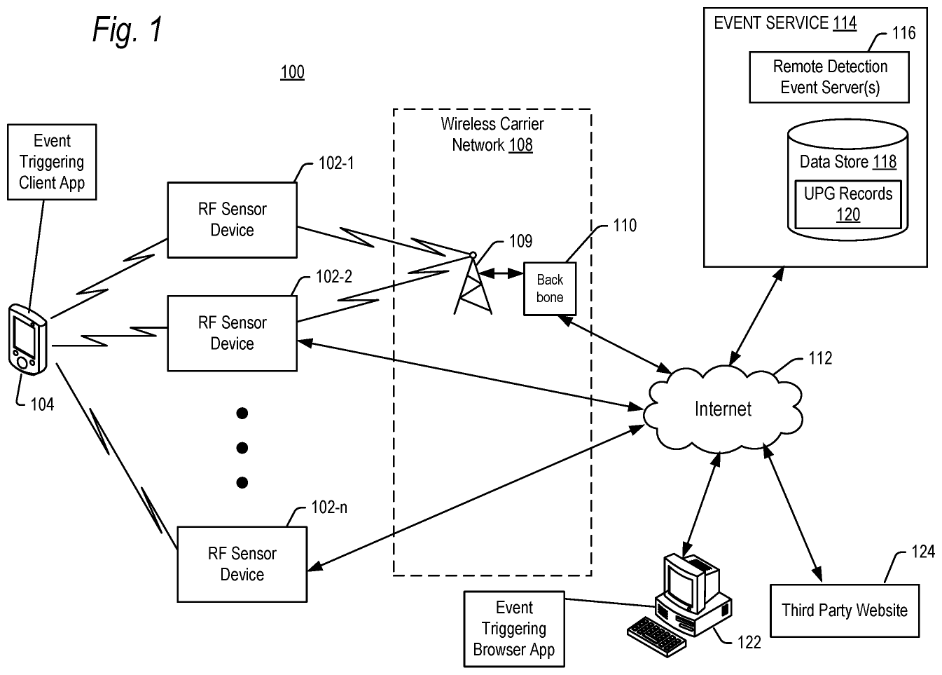

FIG. 1 is a schematic representation of an architecture 100 for implementing the present technology, and within which the present technology may be in implemented. RF sensing devices 102-1, 102-2, . . . , 102-n (collectively RF sensing devices 102, or simply sensing devices 102) may be provided at any of a wide variety of geographic locations, including stores, vendors, restaurants, food courts, movie theaters, schools, hotels, convention centers, buildings, homes, parks, indoor and outdoor venues, and other locations. In embodiments, the RF sensing devices may be hardware devices configured as 4G LTE Small cells, Wi-Fi Access Points, 5G Small cells or a number of other devices or components at a location providing wireless access to a cellular, broadband or Internet protocol network. Each RF sensing device may further include a sensor for detecting the presence of a mobile device within a predefined proximity of the RF sensing device, and for receiving encoded personal identification information from a mobile device as explained below. Each such location may include one or more RF sensing devices 102. The RF sensing devices 102 are provided for detecting the presence of a user mobile device 104.

User mobile device 104 may often be a mobile telephone, but may be any of a wide variety of other mobile devices including a laptop, tablet, smart watch, computing system within an automobile, or other devices capable of wirelessly transmitting identification information associated with the user of the mobile device 104. While FIG. 1 shows a single mobile device 104 communicating with multiple RF sensing devices 102, the mobile device 104 may communicate with a single RF sensing device at a time. As a user travels about, the user's mobile device 104 may trigger different RF sensing devices 102 at different times. Additionally, while FIG. 1 shows a single mobile device, a given sensing device 102 may detect multiple different mobile devices 104 at a given time.

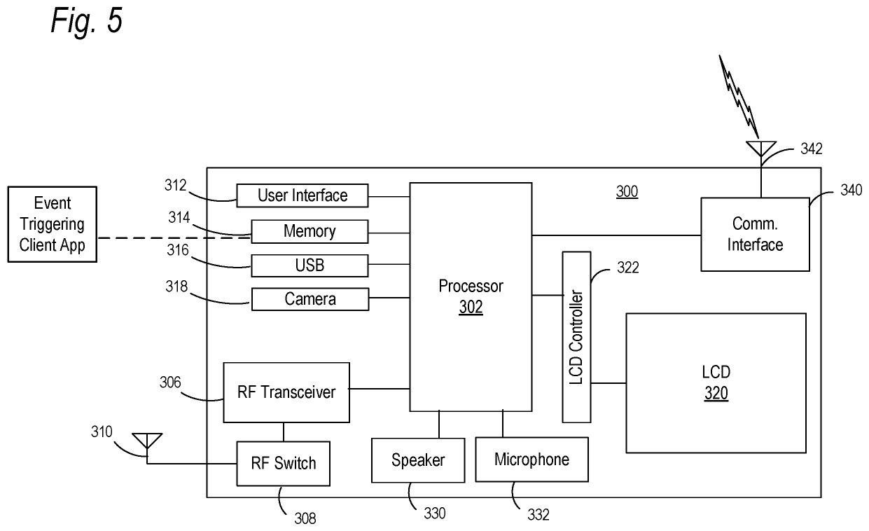

A sample block diagram of the hardware of a mobile device 104 is shown in FIG. 5 described below. However, in accordance with aspects of the present technology, mobile devices 104 may include a processor and memory for executing an event triggering software application which hashes or otherwise processes the personal identification information (“PII”) into encoded data that is transmitted from the mobile device 104 to an RF sensing device 102. The PII may also include an ID for the RF sensing device 102 and/or a location of the RF sensing device 102. Further details of the operation of the client-side event triggering software application are described below.

The RF sensing devices 102 may in turn include a network interface and transmitter for transmitting the encoded PII according to any of a variety of transmission protocols to a remove event service 114. The encoded PII may be transmitted by a wireless carrier network 108 to the Internet 112, which may in turn send the encoded PII to the event service 114. The wireless carrier network 108 may for example be one or more of a cellular, broadband and/or Internet service provider, including for example AT&T, Sprint, Verizon, Xfinity and/or other such service providers that receive and transmit mobile, broadband and/or HTTP over TCP/IP signals and data.

FIG. 1 illustrates a first RF sensing device 102-1 configured to transmit data via a cellular carrier network transmitting for example via the LTE mobile communication standard. In such an embodiment, the RF sensing device 102-1 communicates with via a cellular carrier network 108 including base stations 109 (one of which is shown) for forwarding data and software from RF sensing device 102-1 to a mobile network backbone 110. Backbone 110 may in turn have a network connection to the Internet 112.

RF sensing devices 102 may alternatively or additionally communicate with the network 108 using WiFi or wireless LAN connectivity to connect to the Internet 112. RF sensing device 102-2 is an example of an access point capable of connecting to the Internet via a cellular network and/or a WiFi connection. RF sensing device 102-n is an example of an access point configured as a WiFi connection to the Internet 112. It is understood that a given RF sensing device 102 may communicate with the Internet 112 by one or more other wired or wireless communication protocols.

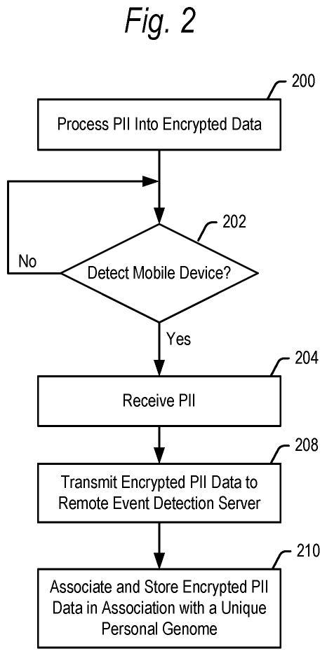

FIG. 2 is a flowchart illustrating the operation of embodiments of the present technology. As noted above, mobile devices 104 may execute a client-side event triggering software application for encrypting personal identification information on the mobile device in step 200. Once encrypted at a mobile device 104, any information from the mobile device 104 or related to the location of the mobile device 104 is encoded such that the association with the actual mobile device data, and thus the specific individual, will be unknown to anyone outside of the carrier network 108. However, the encrypted PII data will still be distinctive to the user of mobile device 104.

When a mobile device 104 is within a given proximity of an RF sensing device 102, the RF sensing device 102 is able to detect its presence in step 202, and receive encrypted PII associated with the mobile device 104 in step 204. The encrypted PII data may then be transmitted via the carrier network 108 and/or the Internet 112 to an event service 114 in step 208.

As used herein, an ‘event’ refers to detection of a mobile device 104 by an RF sensing device 102. The event service 114 includes a remote event detection server 116 and an associated data store 118 (connected to the event server 116 directly or via the Internet 112. Upon receipt of the encrypted PII data, the remote event detection server 116 may perform a lookup to see if a record already exists in data store 118 associated with the received encrypted PII data. In particular, each record stored in data store 118 may have a unique personal genome. Each time the remote event detection server 116 receives encrypted PII data, it checks to see whether a unique personal genome (UPG) record 120 exists in data store 118 which is associated with received encrypted PII data. If so, the unique personal genome record is updated in step 212 to include the new encrypted PII data. If encrypted PII data received at the remote event detection server 116 has no associated UPG record 120, a UPG record 120 is generated in step 212, associated with the received encrypted PII data, and the new UPG record is stored.

It is a feature of the present technology that PII from a given user may be received at event service 114 from different RF sensing devices 102 and via different wireless carrier networks 108, and still be associated with a single unique personal genome within event service 114. Thus, where a user having a mobile device 104 travels to different areas, and the mobile device is detected by different RF sensing devices 102, all such events will register at event service 114 under the same unique personal genome record 120. It may be that the user's PII from the mobile device 104 is encoded into the same hashed data regardless of the RF sensing device or network that forwards the encoded PII.

Moreover, over time, the event service 114 may use algorithms and heuristics to learn different user devices that belong to a single user. In this case, data from all such user devices determined to belong to a single user may be assimilated under a single unique personal genome record 120. For example, referring again to FIG. 1, a user (having a mobile device 104) may also connect to a third party website 124 via the Internet 112 from one or more secondary computing devices 122. The third party website 124 may in turn received encoded PII from the secondary computing device 122 and transmit that encoded PII to the event service 114. Although received from a different device, the remote detection event server(s) 116 may analyze the encrypted data and determine that the user of the device 122 is the same user of a mobile device 104. In such event, encrypted PII received from the user's secondary device 122 and the user's mobile device 104 may be compiled into the same UPG record 120. Further details of how the event service 114 may determine the devices belonging to a single individual is explained in greater detail below.

The secondary computing device 122 shown in FIG. 1 may be a desktop computer 122, but a user may alternatively connect to the third party web site over the Internet 112 using any of various other secondary computing devices. Such secondary computing devices may include laptops, tablets, smart watches, computing systems within automobiles, or other devices executing browser applications for connecting to the Internet and third party websites 124. The secondary computing device 122 may also be a mobile computing device 104 that is detected by RF sensing devices 102 as described above.

Secondary computing devices 104 may execute an event triggering browser application which hashes or otherwise processes certain personal identification information on secondary computing device 122 into encoded data that is transmitted from the secondary computing device 122 to the third party web site 124 (which in turn transmits the encoded data to the event service 114). Such personal identification information may include for example characteristics of browsers used, browsing history, login IDs, contact information, etc. The encoded PII from the secondary device 122 may also include an ID for the secondary device and/or a location of the secondary device. As noted, the secondary device 122 may also be a mobile device 104. As such, the event triggering browser application executed by secondary device 122 may be (or operate on) a desktop browser or a mobile browser.

In embodiments described above, PII is received within an RF sensing device at a location, encrypted, and then forwarded to the event service via a network 108. This can be described as a client-side event triggering software application. In further embodiments, the event triggering software application for encrypting the personal identification information may be resident on an RF sensing device 102, or on hardware components of a wireless carrier 108. In such embodiments, the personal identification information is transmitted from a mobile device, and is then encrypted by an event triggering software application on the RF sensing device 102 or within the wireless carrier network 108. After encryption within the WAP 102 or wireless carrier network 108, the encoded PII may then be transmitted to the event service 114.

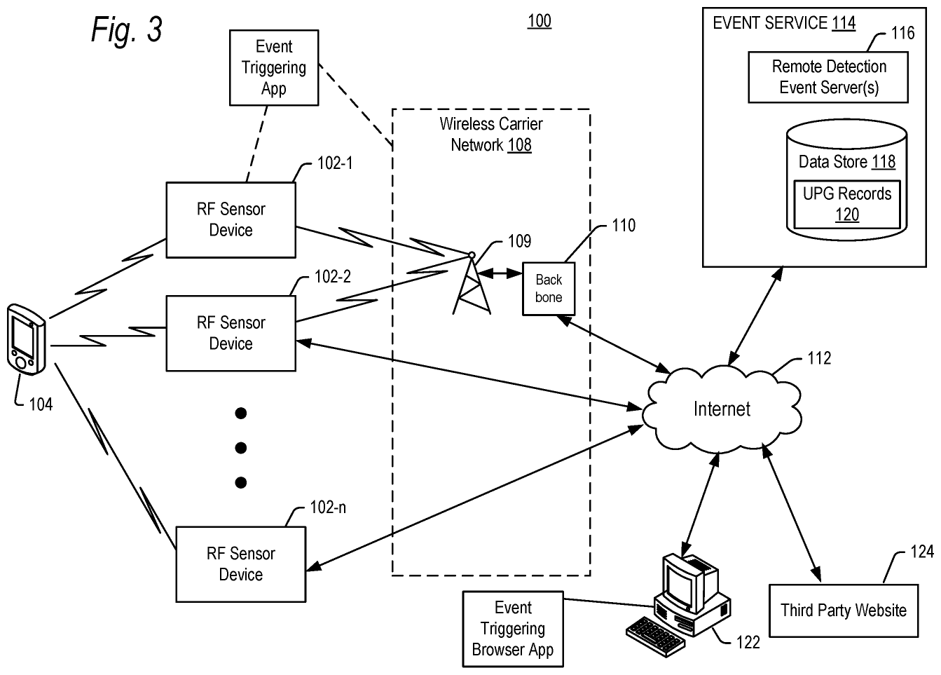

FIG. 3 is a schematic block diagram showing the event triggering software application running on, and executed by, at least one of the RF sensing devices 102 or the wireless carrier network 108. Where run on the wireless carrier network 108, the event triggering software may execute on a computing device such as backbone 110. As with the client-side event triggering software application, once encrypted by the event triggering software application running on the RF sensing devices 102 and/or wireless carrier network 108, any information from the mobile device 104 or related to the location of the mobile device 104 transmitted to event service 114 is encoded such that the association with the actual mobile device data, and thus the specific individual, will be unknown to anyone outside of the carrier network 108. However, the encrypted PII data will still be distinctive to the user of mobile device 104.

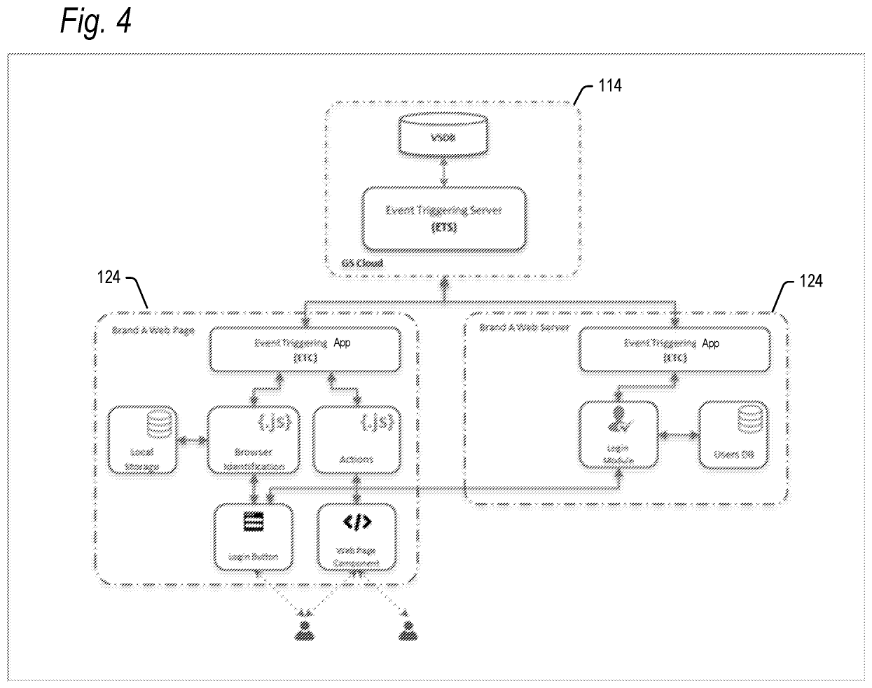

In embodiments described above, PII may be encrypted by an event triggering browser application running the secondary computing device 122. In further embodiments, the event triggering software application for encrypting the personal identification information may be resident on a web server for the third party website. As such, PII may be sent to the third party website. An event triggering software application running on a web server of the third party web site may then encrypt the PII so that any PII sent by the third party website to the event service 114 is encrypted. FIG. 4 is a schematic block diagram of such an embodiment.

In accordance with the present technology, the event service 114 does not store any data that personally identifies an end customer of its services. The event service 114 in the cloud always receives only the anonymized, encoded PII data (which is not in fact personal identification information), and performs all of its processing based on these encoded data. The following description provides one embodiment for encoding of PII data.

In one embodiment, the event triggering software application may execute a one-way hashing process to convert user PII data into anonymized/non-PII data. This hashing process may be run by the event triggering software whether run on a mobile device 104, RF sensing device 102, wireless carrier network 108, secondary device 122 or third party website 124. In one example, the one-way hashing algorithm may be a SHA512/256 Truncated Hashing Software Process. Some advantages of using this process are:
With most new CPUs supporting 64-bits architecture, it is optimal to leverage a SHA512 hashing system since it is faster compared to SHA256 on 64-bit architecture.
However, storing a 512-bit hash is expensive compared to a 256-bit hash, using the truncated 256-bit output provides the necessary balance for security/storage against performance cost of calculating the hash value.
The SHA512/256 truncated hashing process is resistant to length extension attacks.
As an additional security enhancement, a 128-bit “Secret Key” is concatenated to each PII data before creating the hash output.

The solution supports three different methods for anonymizing the mobile subscriber and web account login name data. The AI platform nodes support configuration data that selects one of the three methods for creating non-PII data. The 128-bit secret key is stored within the wireless operator network, Brands login databases, and the AI platform executed within the event service via a secure and encrypted information transfer.

In embodiments, the hashing algorithm provides a dedicated Secret Key for each PII data. Thus, in this configuration, each PII data of every mobile subscriber of a wireless operator and web account login name is concatenated with a secret key generated per PII data. In this configuration, the PII data is anonymized as follows:
SHA512/256(secret_key_imsi+IMSI)
SHA512/256(secret_key_msisdn+MSISDN)
SHA512/256(secret_key_imei+IMEI)
SHA512/256(secret_key_gsSensorId+IMSI+MSISDN+IMEI)
SHA512/256(secret_key_browserId+UserName)

In embodiments, the hashing algorithm provides a dedicated Secret Key per mobile subscriber. Thus, in this configuration, each PII data of every mobile subscriber of a wireless operator and web account login name is concatenated with a secret key generated per user. In this configuration, the PII data is anonymized as follows:
SHA512/256(secret_key_sub+IMSI)
SHA512/256(secret_key_sub+MSISDN)
SHA512/256(secret_key_sub+IMEI)
SHA512/256(secret_key_sub+IMSI+MSISDN+IMEI)
SHA512/256(secret_key_sub+UserName)

In embodiments, the hashing algorithm provides a single Secret Key for all PII data and mobile subscribers. Thus, in this configuration, each PII data of every mobile subscriber of a wireless operator is concatenated with a single secret key. In this configuration, the PII data is anonymized as follows:
SHA512/256(secret_key+IMSI)
SHA512/256(secret_key+MSISDN)
SHA512/256(secret_key+IMEI)
SHA512/256(secret_key+IMSI+MSISDN+IMEI)
SHA512/256(secret_key+UserName)

The above description of hashing algorithms is by way of example only, and it is understood that PII data may encoded and encrypted by other methods in further embodiments.

In accordance with the present technology, user data is being anonymized by doing a one-way hashing, which means there is no way of getting the original data back in the event service 114 or anyone trying to hack event service 114. However, wireless carriers 108 and/or third party websites 124 that also already have customer data can use the hash process and their user data to tie the subscriber and data back together. The main distinction being that the data is being randomized/anonymized before being sent outside of the secure environment (e.g., wireless carrier network 108) versus being encrypted before being sent. Encryption can be hacked and used whereas randomized anonymous data is useless and cannot be put back together.

In accordance with the present technology, user proximity (location) and personal identification information may be obtained and encoded. This encoded data may then be advantageously used by the event service 114 to enrich customer profiles that might include telephone numbers and Internet-based information such as login IDs and browser signatures, as well as non-Internet based data such as physical features, demographic data, contact information, and purchase history.

Using methods such as Machine Learning technology, the event service 114 may use encoded PII data to reliably provide consumer intelligence to build personalized offerings with secure built-in anti-fraud features and EU GDPR privacy compliance. By considering the consumer behavior, using complex Deep Learning algorithms, the AI platform executed by the remove detection event (or other) servers within the event service 114 predicts consumer interests, context based on activities and products, while automatically adapting with evolving behaviors and interests. It provides a new and innovative path for wireless service providers, publishers, advertisers and vendors to connect personally with the target audience. Again, this is provided while maintaining user personal information in complete privacy.

The AI platform executed within the event service 114 creates the personal genome record 120, per individual, by matching the data collected in real time with digital information, device IDs, browsing habits, demographic data and ad exposure. The AI platform supports multiple methods for integration with a wireless carrier network 108, which results in deterministic matching of wireless devices within the personal genome.

The collection of consumer data and behavior is supported by a Consumer Intelligence Gatherer engine executed on the remote event detection (or other) servers within the event service 114. The Consumer Intelligence Gatherer consists of a variety of technology subsystems supporting the collection of consumer data and behavior in real time. It is responsible for anonymizing personal identifying information of each consumer. Its main goal is to detect consumer presence in person at customer premise, and virtually at online websites. Along with presence detection, the subsystems collect information about consumer behavior. All of the collected information is reported back to AI platform residing in the event service 114 in a secure manner.

FIG. 5 is a block diagram of an embodiment of mobile device 104, in which the device 104 is a mobile telephone. Mobile device 104 may have a conventional hardware configuration and may operate to perform all of the functions conventionally known for mobile telephones. Additionally, as explained hereinafter, a software application program and other software components may be loaded onto mobile device 104 to encode data as described above.

Mobile device 104 may include a processor 302, which may be part of or include a digital baseband and/or an analog baseband for handling digital and analog signals. As is known, processor 302 may include a variety of electronics for handling incoming and outgoing digital voice and data signals. RF Transceiver 306 and switch 308 are provided for receiving and transmitting analog signals, such as an analog voice signal, via an antenna 310. In embodiments, transceiver 304 performs the quadrature modulation and demodulation, as well as up- and down-conversion from dual-band (800 and 1900 MHz) RF to baseband. The various communication interfaces described herein may include a transceiver and/or switch as in transceiver 306 and switch 308.

Mobile device 104 may further include a user interface 312 including a variety of actuators in the form of buttons, dials, switches, etc. for controlling telephone features and operation. Mobile device 104 may further include memory 314, for storing telephone numbers, address, etc. Memory 314 may additionally store photographic or video images taken with the mobile device 104. Memory 314 may also store software applications executed by the processor 302 of mobile device 104, including the client-side event triggering software application.

Mobile device 104 may further include a connection 316 for electrically coupling mobile device 104 to another device. Connection 316 may be a USB connection, but it is understood that other types of connections may be provided, including serial, parallel, SCSI and an IEEE 1394 (“Firewire”) connections. Mobile device 104 may further include a camera 318 as is known in the art. An image captured by a lens in the telephone is forwarded to processor 302 (or to some dedicated camera processor), which in turn displays that image on an LCD screen 320 in the telephone. An LCD controller interface 322 may be provided for receiving the signal from the processor 302 and interpreting it for display on LCD 320. LCD 320 and LCD controller 322 may be of known construction. The LCD controller interface 322 may be part of processor 302 in embodiments.

Mobile device 104 may include a speaker 330 of known construction for reproducing voice signals, as well as for outputting various ring tones, interactive voice menus and other stored or received audio files. A microphone 332 of known construction may further be provided for receiving voice signals. Mobile device 104 may further include a communication interface 340 and antenna 342 capable of wireless communication with RF sensing devices 102. A mobile device 104 may include a communication interface 340 operating according to various wireless protocols, including Bluetooth, RF and IR.

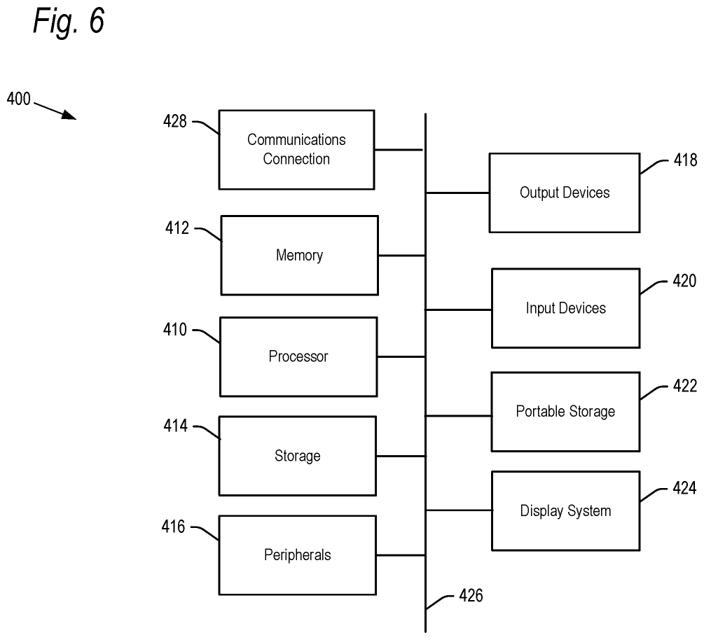

FIG. 6 is a high level block diagram of a computing system 400 which can be used to implement any of the computing devices described herein, including for example embodiments of the mobile device 104, components of the trigger detection WAP 102, backbone 110, remote detection servers 116 and/or secondary device 122. The computing system 400 of FIG. 6 includes processor 410, memory 412, mass storage device 414, peripherals 416, output devices 418, input devices 420, portable storage 422, and display system 424. Computing devices as described herein may include fewer or additional components than those described. For example, a base station may not include peripherals 416, etc. For purposes of simplicity, the components shown in FIG. 6 are depicted as being connected via a single bus 426. However, the components may be connected through one or more data transport means. In one alternative, processor 410 and memory 412 may be connected via a local microprocessor bus, and the mass storage device 414, peripheral device 416, portable storage 422 and display system 424 may be connected via one or more input/output buses.

Processor 410 may contain a single microprocessor, or may contain a plurality of microprocessors for configuring the computer system as a multiprocessor system. Memory 412 stores instructions and data for programming processor 410 to implement the technology described herein. In one embodiment, memory 412 may include banks of dynamic random access memory, high speed cache memory, flash memory, other nonvolatile memory, and/or other storage elements. Mass storage device 414, which may be implemented with a magnetic disc drive or optical disc drive, is a nonvolatile storage device for storing data and code. In one embodiment, mass storage device 414 stores the system software that programs processor 410 to implement the technology described herein. Portable storage device 422 operates in conjunction with a portable nonvolatile storage medium, such as a floppy disc, CD-RW, flash memory card/drive, etc., to input and output data and code to and from the computing system of FIG. 6. In one embodiment, system software for implementing embodiments is stored on such a portable medium, and is input to the computer system via portable storage medium drive 422.

Peripheral devices 416 may include any type of computer support device, such as an input/output interface, to add additional functionality to the computer system. For example, peripheral devices 416 may include one or more network interfaces for connecting the computer system to one or more networks, a modem, a router, a wireless communication device, etc. Input devices 420 provide a portion of a user interface, and may include a keyboard or pointing device (e.g. mouse, track ball, etc.). In order to display textual and graphical information, the computing system will (optionally) have an output display system 424, which may include a video card and monitor. Output devices 418 can include speakers, printers, network interfaces, etc. System 100 may also contain communications connection(s) 428 that allow the device to communicate with other devices via a wired or wireless network. Examples of communications connections include network cards for LAN connections, wireless networking cards, modems, etc. The communication connection(s) can include hardware and/or software that enables communication using such protocols as DNS, TCP/IP, UDP/IP, and HTTP/HTTPS, among others.

The components depicted in the computing system of FIG. 6 are those typically found in computing systems suitable for use with the technology described herein, and are intended to represent a broad category of such computer components that are well known in the art. Many different bus configurations, network platforms, and operating systems can be used.

In summary, the present technology relates to a method of generating stored unique personal genome records, comprising: receiving personal identification information (PII) data regarding a user of a mobile device; encoding the PII data into encoded PII data; detecting the presence of the mobile device with a sensor; receiving the encoded PII upon detecting the presence of the mobile device; and transmitting the encoded PII to an event service.

In another example, the present technology relates to a method of generating stored unique personal genome records, comprising: personal identification information (PII) data regarding a user of a mobile device; detecting the presence of the mobile device with a sensor; receiving the PII upon detecting the presence of the mobile device; encoding the PII data into encoded PII data; and transmitting the encoded PII to an event service.

In a further example, the present technology relates to one or more processor readable storage devices having processor readable code embodied on said processor readable storage devices, the processor readable code for programming one or more processors to perform a method comprising: receiving personal identification information (PII) data regarding a user of a mobile device; detecting the presence of the mobile device with a sensor; receiving the PII at a carrier upon detecting the presence of the mobile device; encoding the PII data into encoded PII data; and storing the encoded PII at an event service in a personal genome record, the event service storing unique encoded PII for a plurality of users in a plurality of personal genome records that can be dynamically accessed.

In another example, the present technology relates to a method of generating stored unique personal genome records, comprising: receiving personal identification information (PII) data regarding a user of a mobile device; detecting the presence of the mobile device at different times by multiple, carrier-specific RF sensors; receiving, at multiple carriers, the PII upon detecting the presence of the mobile device via their carrier-specific RF sensor; encoding, at the multiple carriers, the PII data into encoded PII data; and receiving, from the multiple carriers, the encoded PII data at an event service.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method of generating stored unique personal genome records, comprising:
(a) receiving personal identification information (PII) data regarding a user of a mobile device;
(b) encoding the PII data into encoded PII data;
(c) detecting the presence of the mobile device with a sensor;
(d) receiving the encoded PII upon detecting the presence of the mobile device; and
(e) transmitting the encoded PII to an event service.

2. The method of claim 1, wherein said step of encoding the PII data into encoded PII data comprises the step of hashing the PII data.

3. A method of generating stored unique personal genome records, comprising:
(a) receiving personal identification information (PII) data regarding a user of a mobile device;
(b) detecting the presence of the mobile device with a sensor;
(c) receiving the PII upon detecting the presence of the mobile device
(d) encoding the PII data into encoded PII data; and
(e) transmitting the encoded PII to an event service.

4. The method of claim 3, wherein detection events represent the detection of a particular user device by an RF sensor device and at a known location.

5. The method of claim 3, wherein the detection events persist or consecutively repeat as long as the mobile device remains detectable by the RF sensor.

6. The method of claim 5, wherein the persistence or consecutive repeating of the detection event can be used to infer the presence of a human owner of the device within range of the sensor.

7. The method of claim 3, wherein the mobile device is represented using the same hashed ID regardless of which RF device it is sensed by, provided the RF devices belong to the same underlying wireless carrier.

8. One or more processor readable storage devices having processor readable code embodied on said processor readable storage devices, the processor readable code for programming one or more processors to perform a method comprising:
(a) receiving personal identification information (PII) data regarding a user of a mobile device;
(b) detecting the presence of the mobile device with a sensor;
(c) receiving the PII at a carrier upon detecting the presence of the mobile device;
(d) encoding the PII data into encoded PII data; and
(e) storing the encoded PII at an event service in a personal genome record, the event service storing unique encoded PII for a plurality of users in a plurality of personal genome records that can be dynamically accessed.

9. The machine-readable storage medium of claim 8, wherein the personal genome records can also be enriched with retail data corresponding to the known users from multiple sources.

10. A method of generating stored unique personal genome records, comprising:
(a) receiving personal identification information (PII) data regarding a user of a mobile device;
(b) detecting the presence of the mobile device at different times by multiple, carrier-specific RF sensors;
(c) receiving, at multiple carriers, the PII upon detecting the presence of the mobile device via their carrier-specific RF sensor
(d) encoding, at the multiple carriers, the PII data into encoded PII data; and
(e) receiving, from the multiple carriers, the encoded PII data at an event service.

11. The method of claim 10, wherein data from multiple carriers can be aggregated to form a composite assessment of all human users within a coverage area of the multiple RF sensors.

12. The method of claim 10, wherein events from multiple carriers or multiple devices per carrier can be probabilistically or deterministically associated with a single personal genome.

13. The method of claim 12, wherein data associated with browser signatures and usage is associated with the personal genome.

14. The method of claim 12, wherein machine learning algorithms are applied by the event service to form the personal genome.
